(19) United States
(12) Patent Application Publication
(10) Pub. No.: US 2017/0182891 A1
(43) Pub. Date: Jun. 29, 2017

(54) METHOD FOR ADJUSTING A RANGE PREDICTION OF A MOTOR VEHICLE BASED ON ENVIRONMENTAL CONDITIONS AND MOTOR VEHICLE

(71) Applicant: Audi AG, Ingolstadt (DE)

(72) Inventors: Florian SCHULLER, Ismaning (DE); Michael KLIMESCH, Ingolstadt (DE); Florian HAUBNER, Ingolstadt (DE)

(73) Assignee: Audi AG, Ingolstadt (DE)

(21) Appl. No.: 15/390,186

(22) Filed: Dec. 23, 2016

(30) Foreign Application Priority Data
Dec. 24, 2015 (DE) 10 2015 016 975.0

(51) Int. Cl. B60L 3/12

(52) U.S. Cl. CPC B60L 3/12; B60Y 2200/91; B60L 2260/52; B60L 2240/662

(57) ABSTRACT

A method for adjusting a range prediction of a motor vehicle based on environmental conditions, includes detecting an outer temperature with at least one environmental sensor detecting a spatial environment of the motor vehicle, and determining with the at least one environmental sensor whether the motor vehicle is present in an internal space or an outside space; and based on the detected outer temperature and the detected spatial environment adjusting a range prediction for the motor vehicle.

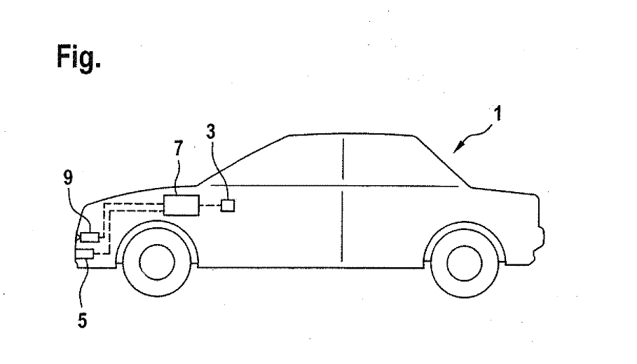

### CROSS-REFERENCES TO RELATED APPLICATIONS

This application claims the priority of German Patent Application, Serial No. 10 2015 016 975.0, filed Dec. 24, 2015, pursuant to 35 U.S.C. 119(a)-(d), the content of which is incorporated herein by reference in its entirety as if fully set forth herein.

### BACKGROUND OF THE INVENTION

The invention relates to a method for adjusting a range prediction of a motor vehicle and a motor vehicle.

The following discussion of related art is provided to assist the reader in understanding the advantages of the invention, and is not to be construed as an admission that this related art is prior art to this invention.

A maximally available range, in particular of an electrically driven motor vehicle, which is also referred to as electric vehicle, strongly depends on environmental conditions and may therefore suddenly change. For example when during summer at an outer temperature of 30° C. an electric vehicle stands in a cooler garage, the predicted range of the motor vehicle determined based on the garage temperature is systematically too high. As soon as the motor vehicle leaves the garage an actual energy requirement for a permanent cooling of the interior of the motor vehicle is recognized—albeit with a significant time delay—and the predicted range abruptly decreases. Because a temperature sensor of the motor vehicle used for determining the outer temperature, which in turn is used for determining the range prediction, is installed in a protected area on the motor vehicle, a relatively long dead time of for example two minutes passes until the range prediction is adjusted. The adjustment is therefore communicated to the driver with a delayed and there is therefore no longer a directly recognizable association with a departure from the garage. Another problem is that temperature gradients, which are typically used for adjusting the range prediction, also occur under other conditions, wherein in particular during summer with temperatures that strongly differ depending on the environment, erroneous adjustments of the range prediction may oftentimes occur.

It would therefore be desirable and advantageous to provide an improved method for adjusting a range prediction of a motor vehicle.

### SUMMARY OF THE INVENTION

According to one aspect of the present invention a method for adjusting a range prediction of a motor vehicle based on environmental conditions, includes detecting an outer temperature with at least one environmental sensor detecting a spatial environment of the motor vehicle, and determining with the at least one environmental sensor whether the motor vehicle is present in an internal space or an outside space; and based on the detected outer temperature and the detected spatial environment adjusting a range prediction for the motor vehicle.

Via the detection of the spatial environment it is possible to in particular determine changes of the spatial environment of the motor vehicle and to adjust the range prediction in direct temporal connection to the change of the spatial environment. This allows avoiding a temporal delay due to the slow change of a measuring value of the outer temperature so that a connection and/or a cause for the adjustment of the range prediction at the time point of the adjustment are recognizable to the driver of the motor vehicle. By using a measurement signal that is assigned to the spatial environment of the motor vehicle for the range prediction a parameter is available which is independent from the measurement value of the outer temperature and with which the accuracy of the range prediction can be increased. As a result the range prediction can operate with increased reliability also in particular in the case of strongly differing temperature conditions as encountered during summer so that erroneous adjustments are reduced, preferably avoided. Overall the driver is informed significantly faster and more reliable and in particular in connection with recognizable changes of the spatial environment of the motor vehicle regarding adjustments of the range prediction, so that a direct relationship to the observed changes of the spatial environment is present and the information is transparent.

The term range prediction in this context means in particular a prediction of a maximally available range of the motor vehicle, in particular of an electric vehicle with electric drive. Hereby the range prediction is performed in dependence on the outer temperature of the motor vehicle because an air conditioning power for air-conditioning an internal space of the motor vehicle—in particular for heating or cooling—significantly influences the available range at a given filling state or state of charge of the energy storage of the motor vehicle. It is also possible that an available retrievable power of an accumulator of the motor vehicle is temperature dependent. A most accurate determination and display of a range, in particular for an electric vehicle, is important information because the driver has to be sure that he can reach an intended destination, in particular when a network of charging stations for the motor vehicle only has a limited coverage and/or a charging process takes an extended amount of time.

The term adjustment of the range prediction means in particular that the range determined based on at least one first parameter and/or the manner in which of the range is determined from the at least one first parameter is changed based on at least one second parameter, which is different from the first parameter. Hereby the first parameter can for example be the outer temperature, wherein the second parameter can for example be a signal of an environmental sensor, which is suited to detect a spatial environment of the motor vehicle. The range prediction is thus not only based on the at least one first parameter but the at least one second parameter is additionally used which increases the accuracy of the range prediction.

The term environmental sensor means in particular a sensor, which is configured to detect a spatial environment of the motor vehicle, in particular a geometric environment of the motor vehicle. Preferably the environmental sensor is configured to recognize whether the motor vehicle is present in an interior space, in particular a closed interior space, or is located outside.

The term environmental sensor further means in particular a sensor in which a parameter, for the observation of which the sensor is configured, and/or a measuring signal of the sensor is at least not directly temperature dependent, at least not temperature dependent in first approximation. Preferably the parameter and/or the measuring signal is/are temperature independent. Such an environmental sensor is also referred to as temperature-independent environmental sensor. Examples therefore are for example a distance indicating sensor, in particular a distance sensor or an optical sensor.

The term spatial environment of the motor vehicle means in particular a geometric environment of the motor vehicle. In particular a spatial environment of the motor vehicle means whether the motor vehicle is present in an internal space, for example a building, in particular a closed internal space, or outside.

According to another advantageous feature of the invention, a change of the spatial environment of the motor vehicle is recognized by means of the environmental sensor, wherein the range prediction is adjusted based on the detected change of the spatial environment. Particularly preferably it is detected by means of the environmental sensor when the motor vehicle leaves an internal space, in particular a closed internal space, and drives into an open environment or outside space. Especially during summer this is typically associated with a significant temperature increase which however can only be detected with a delay by an outer temperature sensor. By means of the environmental sensor on the other hand the change can be detected immediately so that the range prediction can be adjusted in direct temporal association with the departure from the internal space, so that the connection between the adjustment of the range prediction and the departure from the internal space can be recognized by the driver.

According to another advantageous feature of the invention, at least one further environmental sensor for detecting the spatial environment is used, wherein the further environmental sensor is different from the environmental sensor and wherein a signal of the further environmental sensor is used for adjusting the range prediction. Thus preferably a first environmental sensor is provided in order to detect a spatial environment of the motor vehicle, wherein the range prediction is adjusted based on a measuring signal of the first environmental sensor. Additionally at least one second environmental sensor for detecting the spatial environment is provided which is different from the first environmental sensor—in particular with respect to a detected parameter and/or a measuring principle and/or an outputted measuring signal. The measuring signal of the second sensor is used in addition to the measuring signal of the first environmental sensor for adjusting the range prediction. This allows further increasing the reliability of the adjustment of the range prediction. It is also possible to correct erroneous adjustments based on the measuring signal of the first environmental sensor by means of the measuring signal of the second environmental sensor. For example in an embodiment of the method it is possible that a distance-indicating sensor is used as first environmental sensor which can recognize the presence of a motor vehicle in an internal space by detecting walls of the internal space that are arranged in the vicinity of the motor vehicle. So long as the motor vehicle is present in an internal space, for example a garage, or leaves the garage the range prediction can be meaningfully adjusted by means of the measuring signal of the first environmental sensor. However, when the motor vehicle drives through a tunnel the first environmental sensor may generate false positive measuring signals, which recognizes an internal space and thus causes an erroneous adjustment of the range prediction. In order to avoid this an optical sensor can be used as second environmental sensor whose signal is for example based on a traffic sign analysis. Based on the measuring signal of the second environment sensor and the traffic sign analysis a tunnel drive can be recognized and an erroneous adjustment based on the measuring signal of the first environment sensor can be prevented, for example by suppressing the corresponding adjustment of the range prediction.

When driving through a tunnel the previously calculated range is preferably maintained because the motor vehicle is expected not to drive through the tunnel until the end of the drive.

A tunnel drive is generally comparable with a short temporarily limited presence in a garage or generally an internal space. Therefore in the case of such a short presence in an internal space an adjustment of the range prediction is preferably also suppressed, in particular when a presence in an internal space is detected for a time period that is smaller than a predetermined threshold time period.

According to another advantageous feature of the invention, the at least one environmental sensor is selected from a group consisting of a distance indicating sensor or a distance sensor, in particular an ultrasound sensor, a radar sensor, an optical sensor, in particular a camera and a laser scanner. By means of at least one of these environmental sensors fast and reliable information regarding the spatial environment of the motor vehicle can be determined, which are available and can used for adjusting the range prediction.

In particular when the at least one environmental sensor is configured as an optical sensor a traffic sign analysis is preferably assigned to the sensor, by means of which a sign recognition of traffic signs can be performed. This allows obtaining information regarding the spatial environment of the motor vehicle, which can be used for adjusting the range prediction. For example when a tunnel drive is recognized by means of such a traffic sign analysis this result can also be used to prevent an erroneous adjustment of the range prediction based on a change of the outer temperature. The reason for this is that typically a different temperature prevails in a tunnel than outside the tunnel so that without recognizing that the vehicle drives through a tunnel an adjustment of the range prediction would be performed as a result of the change of the measuring signal of a sensor for the outer temperature. Because typically a tunnel drive however only makes up a small part of the overall driving route the changed outer temperature has no influence, or at most only a marginal influence, on the actual range. Therefore an outer-temperature-controlled adjustment of the range prediction can preferably be prevented or suppressed based on the traffic sign analysis.

According to another advantageous feature of the invention, a presence of the motor vehicle in a building is recognized by means of the environmental sensor. In particular a presence of the motor vehicle in a garage is preferably recognized by means of the environmental sensor. As an alternative or in addition the environmental sensor recognizes when the vehicle leaves the building, in particular the garage. Preferably the method thus also includes a building recognition and in particular a garage recognition. When a garage is recognized and the motor vehicle is parked and then leaves the garage an adjustment of the range prediction can be performed in close temporal connection with this event. The information whether the motor vehicle was standing in a building, in particular a garage, at the beginning of the drive is thus preferably used to thereby influence parameters for the observation of an outer temperature and in a particular parameters for the observation of an outer temperature gradient. This allows adjusting the range prediction without delay.

The information whether the motor vehicle is momentarily located in a building, in particular a garage, is preferably determined with a plurality of environmental sensors, in particular by two environmental sensors that are independent of each other and different from each other, for example a distance sensor and an optical sensor.

According to another advantageous feature of the invention, the range prediction is determined by way of the outer temperature. Hereby the outer temperature—as explained above—represents an important variable, which determines the range of the motor vehicle.

In addition the range prediction is determined based on an actual power requirement of the motor vehicle. It is clear that the actual power requirement has an influence on the range of the motor vehicle. Also the power requirement hereby has to be observed and averaged over a sufficiently long period of time, in order to obtain a reliable result for determining the maximum range.

According to another advantageous feature of the invention, the range prediction is adjusted based on a temperature gradient of the outer temperature. In addition the range prediction is preferably adjusted based on a power gradient of the power requirement. Particularly preferably a first threshold value or threshold values is/are defined for the temperature gradient and/or the power gradient, wherein the range prediction is adjusted when at least one of the gradients—in particular with its absolute value—reaches or exceeds the first threshold value assigned to it. On the other hand no adjustment is preferably performed when both gradients, or a gradient which is solely used for the range prediction, does not exceed the first threshold value assigned to it—in particular with its absolute value. By appropriately selecting the first threshold values a too frequent adjustment of the range prediction can be avoided and its accuracy increased.

According to another advantageous feature of the invention, a threshold value for the temperature gradient and/or for the power gradient is changed based on the detected spatial environment. For example a first threshold value can be lowered based on the detected spatial environment and in particular based on a change of the detected spatial environment, to a second threshold value so that a smaller gradient is sufficient to cause an adjustment of the range prediction. Then upon departure from the garage a lower gradient of the power requirement and/or the outer temperature can be sufficient to adjust the range prediction so that the adjustment is faster and occurs in temporal connection with a departure from the garage. Erroneous recognitions can be reduced because in other situations, in particular in the case of an unchanged spatial environment, particularly when recognizing that the motor vehicle is located outside, the threshold value for the gradient can be set upwards again, in particular to the first threshold value, in order to suppress too frequent adjustments and erroneous adjustments of the range prediction. Thus in particular parameters for the observation of the temperature and/or power gradient can be influenced based on the detection of the spatial environment, wherein the sensitivity of the algorithm for the range prediction can be set.

According to another aspect of the invention, a motor vehicle includes at least one outer temperature sensor for detecting an outer temperature of the motor vehicle; at least one environmental sensor for detecting a spatial environment of the motor vehicle; and a range prediction device configured to predict a maximal range of the motor vehicle based on at least the outer temperature detected by the outer temperature sensor and to adjust the predicted maximal range based on a measuring signal of the at least one environmental sensor

According to another advantageous feature of the invention, the range prediction device is further configured to predict the maximal range of the motor vehicle based on a temperature gradient.

According to another advantageous feature of the invention, the motor vehicle is configured as an electric vehicle, in particular as motor vehicle with an electric drive. In connection with an electric vehicle in particular the advantages described above can be realized.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a schematic representation of an embodiment of a motor vehicle according to the invention.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The FIGURE shows a schematic representation of an exemplary embodiment of a motor vehicle 1, which is configured for implementing an embodiment of the method for adjusting a range prediction of a motor vehicle 1 based on environmental conditions. The motor vehicle 1 is preferably configured as an electric vehicle.

The motor vehicle1 has a—preferably protectively mounted—outer temperature sensor 3, which is configured for detecting an outer temperature of the motor vehicle 1. The motor vehicle 1 further has a first environmental sensor 5, which is configured to detect a spatial environment of the motor vehicle 1. The first environmental sensor 5 is configured as a distance-indicating sensor, in particular as a distance sensor, particularly preferably as an ultrasound sensor or as a radar sensor.

The outer temperature sensor 3 and the first environmental sensor 5 are operatively connected with a range prediction device 7, which is configured to perform a range prediction for the motor vehicle 1 based on the detected outer temperature. The range prediction device 7 is also configured to adjust the range prediction based on the detected outer temperature and the detected spatial environment.

The range prediction device 7 is preferably configured to perform the range prediction additionally based on an actual power requirement of the motor vehicle 1. In particular the range prediction device 7 is preferably configured to adjust the range prediction based on a temperature gradient of the outer temperature and preferably based on the power requirement, wherein preferably the adjustment of the range prediction is adjusted based on the detected spatial environment. In particular the range prediction device 7 preferably changes a threshold value for the temperature gradient of the outer temperature and/or the power gradient of the power requirement for adjusting the range prediction based on the detected spatial environment.

The range prediction device 7 is further configured to recognize by means of the environmental sensor 5 a change of the spatial environment of the motor vehicle 1, wherein the range prediction is adjusted based on the change of the spatial environment.

A second environmental sensor 9 is provided, which is different from the first environment sensor 5 with regard to a detected parameter and/or a measuring signal. Also the second environment sensor 9 is used for detecting the spatial environment of the motor vehicle 1. A signal of the second environment sensor 9 is used for adjusting the range prediction by the range prediction device 7, wherein the range prediction device 7 is operatively connected with the second environmental sensor 9.

The second environmental sensor 9 is preferably configured as an optical sensor, in particular as a camera or as a laser scanner. It is possible that a traffic sign analysis is assigned to the second environmental sensor 9 and/or to the range prediction device 7, with which traffic sign analysis a traffic sign recognition can be performed. Hereby it is possible to conclude a spatial environment of the motor vehicle 1 based on recognized traffic signs and to use this information for adjusting the range prediction.

By means of the environmental sensors 5, 9 in particular a presence of the motor vehicle 1 in a building, in particular a garage, is recognized, In addition or as an alternative, the environmental sensors 5, 9 preferably recognizes when the motor vehicle 1 leaves the building, in particular the garage.

Overall it can be seen to that by means of the method and with the motor vehicle 1 a reliable, delay-free adjustment of the range prediction in particular when the spatial environment of the motor vehicle 1 changes, is possible.

What is claimed as new and desired to be protected by Letters Patent is set forth in the appended claims and includes equivalents of the elements recited therein:

What is claimed is:

1. A method for adjusting a range prediction of a motor vehicle based on environmental conditions, comprising:
detecting an outer temperature;
with at least one environmental sensor detecting a spatial environment of the motor vehicle, and determining with the at least one environmental sensor whether the motor vehicle is present in an internal space or an outside space; and
based on the detected outer temperature and the detected spatial environment adjusting a range prediction for the motor vehicle.

2. The method of claim 1, further comprising recognizing with the at least one environmental sensor a change of the spatial environment of the motor vehicle, and adjusting the range prediction based on the change of the spatial environment recognized by the environmental sensor.

3. The method of claim 1, further comprising detecting the spatial environment with a further environmental sensor which is different from the at least one environmental sensor, and using a measuring signal of the further environmental sensor for adjusting the range prediction.

4. The method of claim 1, characterized in that the at least one environmental sensor is selected from the group consisting of a distance-indicating sensor, a distance sensor, an ultrasound sensor, a radar sensor, an optical sensor, a camera and a laser scanner.

5. The method of claim 1, further comprising recognizing with the at least one environmental sensor at least one of a presence of the motor vehicle in a building and a departure of the motor vehicle from the building.

6. The method of claim 1, wherein the range prediction is determined based on the outer temperature.

7. The method of claim 6, wherein the range prediction is additionally determined based on an actual power requirement of the motor vehicle.

8. The method of claim 7, further comprising adjusting the range prediction based on a temperature gradient of the outer temperature.

9. The method of claim 7, further comprising adjusting the range prediction based on a power gradient of the actual power requirement.

10. The method of claim 8, further comprising correcting the adjusted range prediction based on the detected spatial environment.

11. The method of claim 1, further comprising adjusting the range prediction based on a temperature gradient of the outer temperature and based on a power gradient of an actual power requirement of the motor vehicle, and changing at least one of a threshold value for the temperature gradient of the outer temperature and a threshold value for the power gradient of the power requirement based on the detected spatial environment.

12. A motor vehicle comprising:
at least one outer temperature sensor for detecting an outer temperature of the motor vehicle;
at least one environmental sensor for detecting a spatial environment of the motor vehicle; and
a range prediction device configured to predict a maximal range of the motor vehicle based on at least the outer temperature detected by the outer temperature sensor and to adjust the predicted maximal range based on a measuring signal of the at least one environmental sensor.

13. The motor vehicle of claim 12, wherein the range prediction device is further configured to predict the maximal range of the motor vehicle based on a temperature gradient:

14. The motor vehicle of claim 12, wherein the motor vehicle is configured as an electric vehicle.
